(19) United States
(12) Patent Application Publication
(10) Pub. No.: US 2009/0254328 A1
(43) Pub. Date: Oct. 8, 2009

(54) DYNAMIC BAYESIAN NETWORK FOR EMULATING CARDIOVASCULAR FUNCTION

(75) Inventors: Nicolas W. Chbat, White Plains, NY (US); Kees Van Zon, Cold Spring, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/439,610

(22) PCT Filed: Aug. 28, 2007
(86) PCT No.: PCT/IB2007/053459

§ 371 Date: Mar. 2, 2009

Related U.S. Application Data
(60) Provisional application No. 60/823,711, filed on Aug. 28, 2006.

(51) Int. Cl. G06G 7/60; G06N 5/04; G06F 19/00

(52) U.S. Cl. 703/11; 706/52

(57) ABSTRACT

A Dynamic Bayesian Network provides models the cardiovascular system and provides emulation of patient data.

### CROSS-REFERENCE TO RELATED APPLICATIONS

The present application is related to concurrently filed U.S. patent application (ATTY. Docket Number US006845) entitled “Method and Apparatus for Deriving Probabilistic Models from Deterministic Ones.” The disclosure of this application is specifically incorporated herein by reference.

Medical technology continues to improve in an effort to afford the care provider more accurate and faster diagnoses and the patient the best possible medical treatment. As is known, heart disease continues to claim the lives and well-being of people. Often, to determine the needs of a patient, invasive testing is required. The tests can be difficult to administer, time consuming and even dangerous to the patient.

In an effort to improve the diagnostic testing of patients, modeling of physiological systems is investigated. These models have resulted in a few representations of the cardiovascular system (CV).

What is needed, therefore is a method and apparatus of modeling the CV system that overcomes at least the shortcomings described above.

In a representative embodiment, a method of emulating vital patient data comprises: providing an input to a Dynamic Bayesian Network (DBN), the input comprising currently measured patient data; providing another input to the DBN, wherein the other input are not currently measured patient data; and garnering an output of emulated vital patient from the DBN.

In another representative embodiment, a system for emulating vital patient data comprises: a Dynamic Bayesian Network (DBN), the network comprising a plurality of The DBN further comprises: currently measured patient data provided as observations for input nodes; and inferred probabilities of output variables, which are presented to the user in an appropriate manner, or otherwise used by a decision support system.

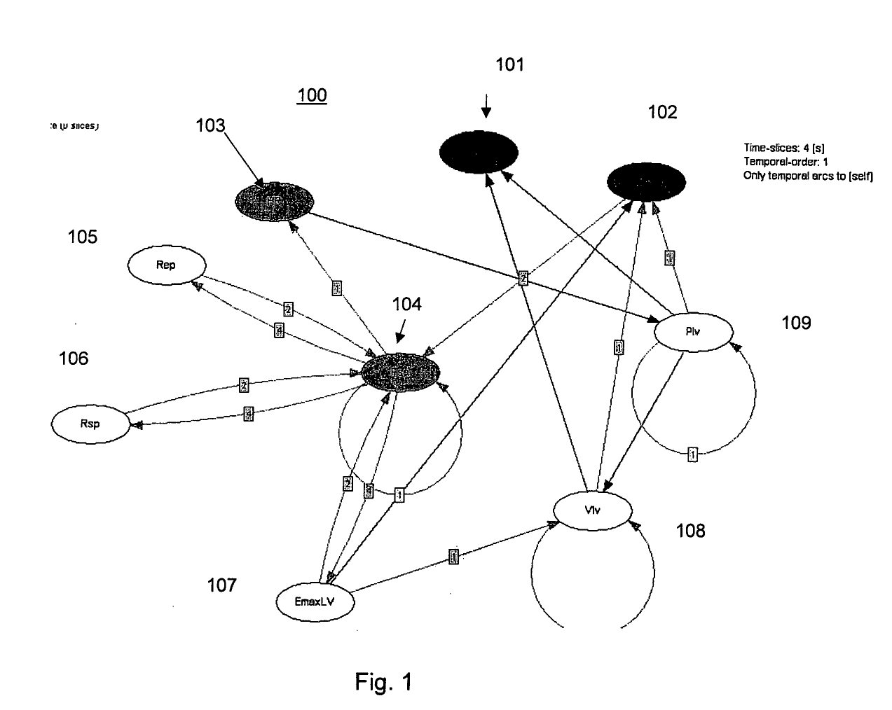

FIG. 1 is a graphical representation of a Dynamic Bayesian Network (DBN) of a human cardiovascular system (CV) in accordance with a representative embodiment.

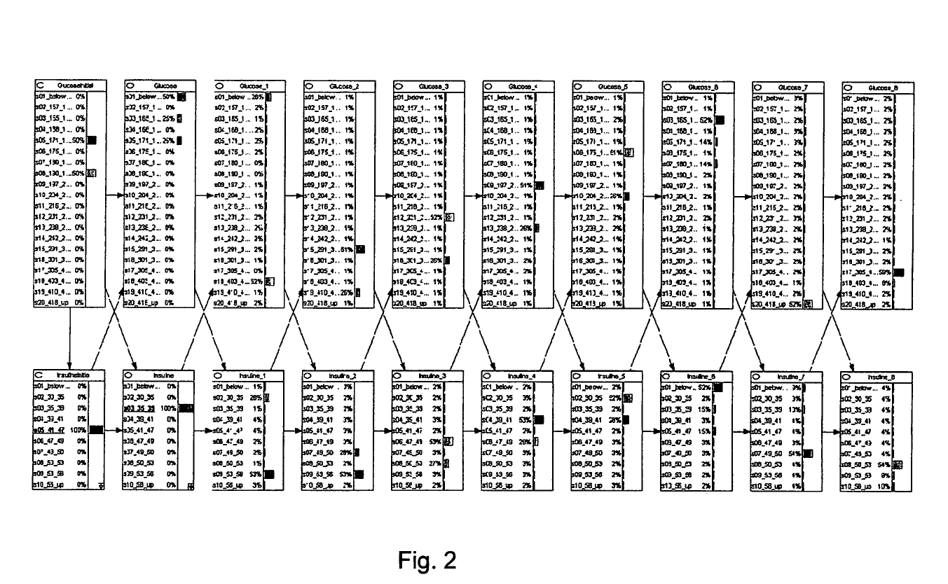

FIG. 2 is a conceptual representation of data tables and their interrelationship in accordance with a representative embodiment.

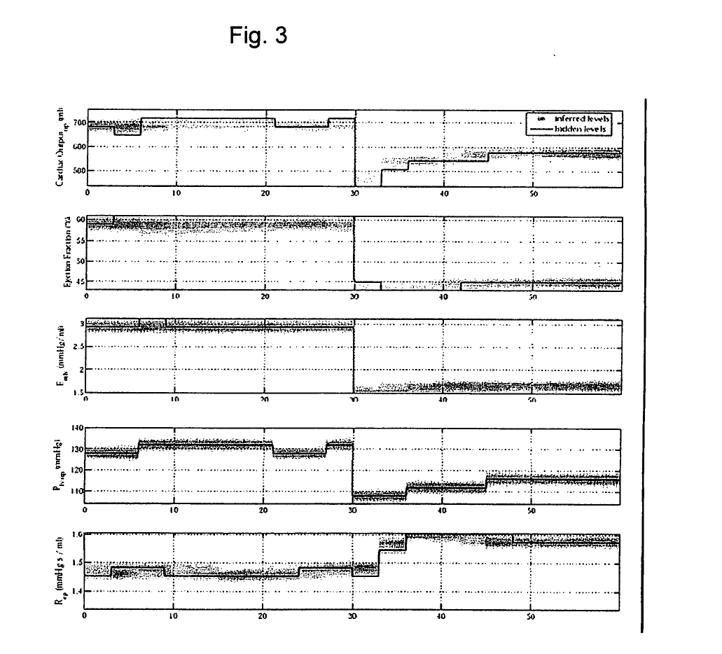

FIG. 3 are conceptual representations of output parameters of a DBN CV system in accordance with a representative embodiment.

In the following detailed description, for purposes of explanation and not limitation, illustrative embodiments disclosing specific details are set forth in order to provide a thorough understanding of the present teachings. Moreover, descriptions of well-known devices, hardware, software, firmware, methods and systems may be omitted so as to avoid obscuring the description of the illustrative embodiments. Nonetheless, such hardware, software, firmware, devices, methods and systems that are within the purview of one of ordinary skill in the art may be used in accordance with the illustrative embodiments. Finally, wherever practical, like reference numerals refer to like features.

The detailed description which follows presents methods that may be embodied by routines and symbolic representations of operations of data bits within a computer readable medium, associated processors, microprocessors, digital storage oscilloscopes, general purpose personal computers, manufacturing equipment, configured with data acquisition cards and the like. In general, a method herein is conceived to be a sequence of steps or actions leading to a desired result, and as such, encompasses such terms of art as “routine,” “program,” “objects,” “functions,” “subroutines,” and “procedures.”

The apparatuses and methods of the illustrative embodiments are described in implementations of testing of the human cardiovascular system. It is emphasized that this is merely illustrative; and it is emphasized that the apparatuses and methods may be implemented in other testing environments. For example, one of ordinary skill in the art, after reviewing the present teachings, may adapt the teachings to the testing of other physiological systems. Moreover, the apparatuses and methods may be implemented in veterinary testing as well in the interest of treating animals.

FIG. 1 is a graphical representation of a Dynamic Bayesian Network (DBN) 100 of a human cardiovascular system (CV) in accordance with a representative embodiment. The network includes output nodes 101, 102, which are, illustratively the heart's ejection fraction (EF) and cardiovascular output (CardioOut), respectively. These nodes represent data that are determined by the DBN network as described in conjunction with representative embodiments. In the present embodiment, the EF and CardioOut are determined from measured data and probabilistic modeled data, as otherwise these important data are garnered through invasive testing. As such, the care giver can beneficially garner these data without invasive testing.

A heart rate (HR) node 103 and a systemic arterial pressure (Psa) node 104 are included in the network 100. These nodes represent the only two directly measured data nodes of the DBN of the present representative embodiments. As will be appreciated, these are minimally invasive and quite ubiquitous in medical diagnosis and treatment. As will be appreciated as the present description continues, by providing these data inputs, the EF 101 and CardioOut 102 may be readily determined via probabilistic inference.

In the representative embodiment, a model of the interrelated cardiovascular system is modeled with nodes, arcs and CPT's. One type of node is an auxiliary node. Auxiliary nodes 105-109 are, respectively, left ventricular pressure (PLV), left ventricular volume (Llv), left ventricular contractility (Lvc), resistance of the peripheral extrasplanchnic section of the systemic circulation (Rrp) and resistance of the peripheral splanchnic section of the systemic circulation (Rsp).

Nodes 105-109 are useful in the modeling of the human CV system, but are not readily garnered from the patient. However, these nodes are part of a mathematical model that represents the system. To this end, a system of ordinary differential equations may, for example, be used to mathematically model the CV. These equations are then provided in a relational manner to determine the DBN 100. The DBN 100 then provides the desired outputs, which in the present example, are the EF and CardioOut.

The relational aspects of the DBN 100 include delay. To this end, there is a delay between one systemic event and another systemic event. For example, there is a delay between the measured system arterial pressure 104 and the heart rate 103. This delay is represented in FIG. 1 as a ‘1’ and has a unit selected by the system designer based on real-time data parameters. For instance, there may be a delay of one heartbeat, or a delay measured in seconds that are provided in the DBN 100.

The arrows between the nodes of the DBN also show the direction of the delay. Moreover, certain physiological phenomena directly affect themselves in a delayed manner. For example, the Llv 108 and the Plv 109 are impacted in a delayed manner, which is shown as an arrow that begins and ends on the same node.

In line with the DBN concept, a prior or conditional probability table is associated with each node. Each table contains a set of prior or conditional probabilities that determine the probability of the corresponding node being in a particular state. If the node has no parents, these probabilities are unconditional (prior); if the node has parents, these probabilities are conditioned on the state of each parent (conditional). These probabilities can be determined from domain literature, from domain experts, or from relevant patient data. If not available, the latter may be obtained from a deterministic model, e.g. as described in [refer to other disclosure].

When the cardiovascular DBN is in use, input nodes 103,104 may be given the values observed for a particular patient, upon which the inference engine associated with the DBN will calculate the probabilities for each output state of nodes 101,102, for a preferred number of time units. These probabilities will be updated each time new observations are entered. Note that inference engines for DBNs are well known and readily available in the field. Further details of DBNs may be found, for example in “Modeling Physiological Processes using Dynamic Bayesian Networks” by J. Hulst (Thesis in Partial Fulfillment for the Requirements of Master of Science Degree at the University of Pittsburgh (2006)), the disclosure of which is specifically incorporated herein by reference. Moreover, the ordinary differential equations (ODEs) of the model may be represented in MatLab or other commercially available software.

To illustrate this process in accordance with a representative embodiment, FIG. 2 shows ten time-units of a simple DBN for glucose estimation based on insulin doses. The insulin dose is provided for the first two time units, after which the inference engine calculates the probabilities of the blood glucose levels and insulin levels for the next eight time units.

FIG. 3 are conceptual representations of output parameters of a DBN CV system in accordance with a representative embodiment. Notably, in operation, the input data (e.g., HR and Psa) are provided. After iterations by the DBN 100, the desired parameters are determined and provided as an output thereto. (Please elaborate on FIG. 3).

Certain benefits and advantages of the DBN 100 are realized. Notably, the DBN 100 allows the health care provider (HCP) to run scenarios in order to understand the patient's reactions to different therapies, and presents values for physiological variables that are otherwise costly or even impossible to measure. The DBN beneficially emulates the cardiovascular system, although other systems may also be emulated. Beneficially, the model of the CV is deterministic and a probablistic relational representation is provided. This clarifies the coupling and causal effects of different CV variables, and can be directly used clinically. Another advantage is that, when used in real-time and measurements are required, the CV DBN possesses an inherent robustness in terms of errors and uncertainties due to measurement or otherwise.

While representative embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A method of emulating vital patient data, the method comprising:
providing an input to a Dynamic Bayesian Network (DBN), the input comprising currently measured patient data;
providing another input to the DBN, wherein the other input are not currently measured patient data; and
garnering an output of emulated vital patient from the DBN.

2. A method as claimed in claim 1, wherein the vital patient data is cardiovascular data.

3. A method as claimed in claim 1, wherein the other data are relational data.

4. A method as claimed in claim 1, wherein the measured patient data and the other data are weighted in the method.

5. A system for emulating vital patient data, the method comprising:
a Dynamic Bayesian Network (DBN), the network comprising a plurality of nodes, comprising:
currently measured patient data provided as observations for input nodes; and
inferred probabilities of output variables, which are presented to the user in an appropriate manner, or otherwise used by a decision support system.

6. A system as claimed in claim 5, wherein the DBN comprises one or more of nodes: a left ventricular pressure (PLV) node, a left ventricular volume (Llv) node, a left ventricular contractility (Lvc) node, a resistance of the peripheral extrasplanchnic section of the systemic circulation (Rrp) node, and a resistance of the peripheral splanchnic section of the systemic circulation (Rsp) node.

7. A system as claimed in claim 6, wherein the nodes are auxiliary nodes.

8. A system as claimed in claim 5, wherein the nodes include measured patient data nodes.
